(19) United States
(12) Patent Application Publication
(10) Pub. No.: US 2006/0255205 A1
(43) Pub. Date: Nov. 16, 2006

(54) Small remotely controllable aircraft

(75) Inventors: Peter Gleich, Abensberg (DE); Franz Maier, Bad Feilnbach (DE)

Correspondence Address: CROWELL & MORING LLP;INTELLECTUAL PROPERTY GROUP, P.O. BOX 14300, WASHINGTON, DC, 20044-4300, US

(73) Assignee: LFK-Lenkflugkoerpersysteme GmbH, Unterschleissheim (DE)

(21) Appl. No.: 11/314,316

(22) Filed: Dec. 22, 2005

(30) Foreign Application Priority Data
Dec. 23, 2004 (DE) 10 2004 061 977.8

(51) Int. Cl. B64C 3/56

(52) U.S. Cl. 244/49; 244/3.27

(57) ABSTRACT

A small aircraft has a fuselage (airframe), control apparatus, and a drive. A propeller electric drive, a power supply, a TV camera, data transmission and steering electronics, and a warhead and/or a weapon system are integrated in the fuselage. Collapsible and/or foldable wings, control surfaces, and propellers are positioned on the fuselage. The small aircraft according to the invention may be equipped with different weapon systems for combating different targets or for different missions.

### BACKGROUND AND SUMMARY OF THE INVENTION

This application claims the priority of German patent document 10 2004 061 977.8, filed Dec. 23, 2004, the disclosure of which is expressly incorporated by reference herein.

The present invention relates to a small aircraft having a fuselage (airframe), means for control, and a drive.

Small aircraft of this type are desirable, not only as a supplementary munition for infantry, but also for border patrol, anti-terror units, etc., which may use them to reconnoiter and combat snipers, hostage takers, terrorists, etc., for example, as well as other targets in non-observable and/or urban territories and within buildings.

Known observation drones, which are based on the rotary flight principle, can assume the flight states of forward movement and hover flight. However, their disadvantages are that rapid flight (sufficient for combating specific targets) and rapid speed changes are not possible. Also, they cannot be fired from a starting tube, and high-agility flight maneuvers and combating targets using weapons also cannot be performed.

One object of the present invention, therefore, is to provide a small flying body, which can be used to perform the cited tasks and which does not have the disadvantages of the known embodiments.

This and other objects and advantages are achieved by the small aircraft according to the invention, in which collapsible or foldable wings, control surfaces and propellers are position on the fuselage, while a propeller electric drive, a power supply, a TV camera, data transmission and steering electronics and a warhead or weapons system are integrated into the fuselage.

Other objects, advantages and novel features of the present invention will become apparent from the following detailed description of the invention when considered in conjunction with the accompanying drawings.

### BRIEF DESCRIPTION OF THE DRAWINGS

FIGS. 1a and 1b show a first embodiment of a small aircraft according to the present invention, in a ready state and in a collapsed state;

FIGS. 2a and 2b show a second embodiment of the small aircraft according to the present invention, in the ready state and in the collapsed state; and

FIGS. 3a and 3b show a third embodiment of the small aircraft according to the present invention, in the ready state and in the collapsed state.

FIG. 4 is a schematic depiction of the body of the aircraft, and the components mounted in or on it.

### DETAILED DESCRIPTION OF THE DRAWINGS

FIGS. 1a and 1b show a first embodiment of the small aircraft according to the present invention, which has a fuselage (airframe) 1, in whose interior, among other things, the navigation, steering, data transmission and control electronics 41 and modular weaponry 42, such as a warhead or a mini-weapon charge are disposed. On the front end 1a, the aircraft has a camera 6 which may be controlled by a cardan joint 6a; camera images may be transmitted to the operator via data transmission electronics 41.

Furthermore, extendable canard control surfaces 2 for position control, and extendable lattice wings 3 for aerodynamic flight stabilization are attached to the fuselage. At the rear end 1b, the aircraft contains an electric drive 4 having folding propellers 4a.

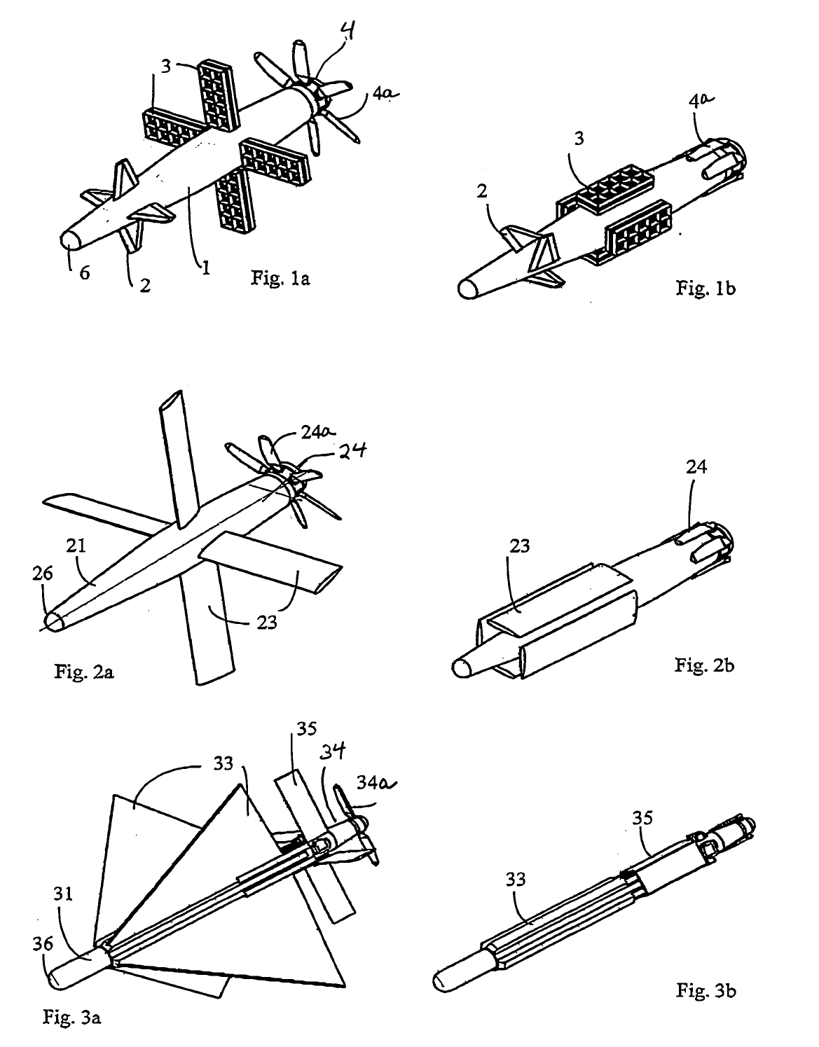

FIGS. 2a and 2b show a further embodiment of the invention, in which the wings 23 are mounted so they are rotatable using control surface steering gears 23a positioned in the aircraft 21 for controlling the roll position and the roll torque. The drive motor 24 for the folding propeller is mounted using a cardan joint 24a on the fuselage. A camera 26 is again positioned on the front end.

Finally, FIGS. 3a and 3b show a further embodiment, in which folding wings 33 are positioned fixed on the fuselage. An extendable Cartesian stern tail unit 35 is used for position control, which a motor having a folding propeller 34 is again used for the drive at the fuselage end.

Each of the above embodiments has an airframe (fuselage), in which a directable mini TV camera is integrated in the front. This is followed by the components of mini weapon charge, data transmission electronics, steering and control electronics, radio receiver, and power supply 43. The electric drive motor 4, which drives a commercially available foldable pusher propeller 4a in normal forward flight, is mounted at the rear of the small aircraft 1b.

The rotational direction of the electric motor 4 may be changed over during flight, so that in this case the propeller first brakes the aircraft and then may bring it into a hover state, in which the aircraft “hangs on the propeller” with the camera downward. In this position, it may perform controlled lateral and height changes.

Four Cartesian collapsing and/or folding wings are attached to the outside of the airframe, which arrangement allows the small aircraft to be housed in a transport and starting container, in its collapsed/folded state. The wings may be implemented as planar wings, as shown in FIGS. 2 and 3, or as lattice wings, as shown in FIG. 1. Instead of the Cartesian wing/control surface arrangement, an arrangement having three lift/control elements in each case may be selected.

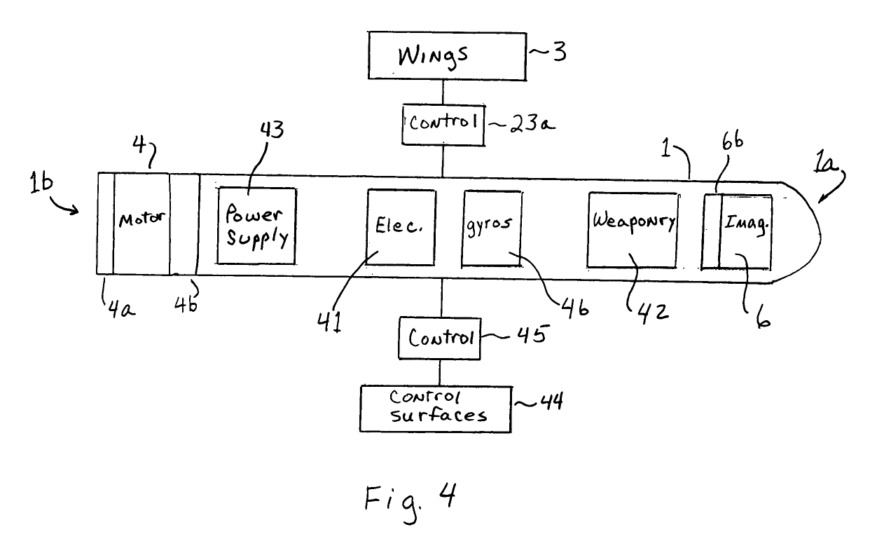

In the exemplary embodiments in FIGS. 1 and 3, four Cartesian aerodynamic control surfaces (44 in FIG. 4) , which are positioned at the front or stern, are used for controlling the small aircraft. The control surfaces 44 are each driven by an electrical control surface steering gear 45, which may be activated independently of one another as in classical flying body concepts. Control surface deflections for rolling, pitching, and yawing can be generated by appropriate superimposing of the four individual control surface deflections.

In the transport state in the starting container, the control surfaces are also collapsed, in the same manner as the wings, and are extended approximately simultaneously when the wings unfold.

The small aircraft according to the invention is steered by the operator (for example, a soldier) using radio remote-control, while automatic position and/or rate of rotation stabilization of the small aircraft are performed through triaxial miniature gyroscopes 46 (FIG. 4). The steering and control of the small aircraft is thus greatly simplified.

In forward flight, the small aircraft is controlled like a classical Cartesian aricraft. In hover flight, the lateral movement in the y and z directions of the axial system fixed on the flying body are controlled by a different system of the control surface angle assignment than in forward flight. Upon the transition from one flight state into the other (that is, between forward flight and hover flight), there is an automatic changeover to the particular relevant control system.

Another control concept is implemented in the flying body in FIG. 2. A special electric drive motor 24 having two rotors rotating in opposite directions having two opposing commercially available folding propellers is mounted at the rear of the aircraft. The electric motor may have its rotational direction changed over during flight, such that in the propeller first brakes the aircraft, and then may bring it into a hover flight state, in which the small flying body “hangs on the propeller” with the camera downward and may perform controlled lateral and height changes.

The electric motor 4 is mounted using a cardan joint 4b at the rear of the aircraft 1b, so that it may be pivoted arbitrarily around to perpendicular transverse axes of the flying body. Therefore, a vectored-thrust control of the flying body may be implemented, and the aircraft is controlled about the two transverse axes of the aircraft (pitching and yawing axes) by the electric motor 24, which may be pivoted on the cardan joint 4b and has the opposing propellers 24a.

Through the opposing propellers, the resulting torque generated by the electric motor around the longitudinal axis of the flying body is theoretically canceled out. However, a minimum torque will always result in practice through interference. In order to level out this torque, relatively small roll control surfaces corresponding to the cardan control surfaces 2 and/or the rear tail unit 35 are sufficient, if necessary; they may be housed either in the stern or in the nose area of the flying body. These roll control surfaces are driven by one or more electrical steering gears.

In the transport state in the starting container, the control surfaces are collapsed like the wings and are extended approximately simultaneously with the wing unfolding.

The small aircraft according to the invention is steered by the operator (soldier) using radio remote-control, with automatic position and/or rate of rotation stabilization being performed through triaxial miniature gyroscopes 46. The steering and control of the aircraft is thus greatly simplified.

In forward flight, the aircraft is controlled like a classical Cartesian flying body by pivoting the electric motor 4. In hover flight, the lateral movement is also controlled by pivoting the motor. In both flight states, the roll position is controlled via the aerodynamic roll control surfaces.

The directable TV/IR camera 6 in the nose of the aircraft transmits its images via a data link to the operator (soldier), who steers the small flying body on the basis of the video through corresponding control inputs in the remote controller.

The aircraft may be equipped with different weapon systems 42 for combating different targets or for different missions. In addition to lethal weapon systems such as explosive/shrapnel charges and mini-P charges, nonlethal weapons such as flashbang charges or poison gases, etc. may be used.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A small aircraft having a fuselage, means for control, and propulsion apparatus, wherein:
the propulsion apparatus comprises a propeller electric drive;
the propulsion apparatus, a power supply, a TV camera, data transmission and steering electronics, and at least one of a warhead or a weapon system are integrated in the fuselage; and
collapsible or foldable wings, control surfaces, and propellers are positioned on the fuselage.

2. The small aircraft according to claim 1, wherein:
the propeller electric drive comprises a propeller motor; and
the propeller motor may have its rotational direction changed over during flight for transfer of the aircraft into the hover state.

3. The small aircraft according to claim 2, wherein:
said collapsible or foldable wings comprise Cartesian wings; and
said collapsible or foldable control surfaces comprise Cartesian, aerodynamic control surfaces, each having a separate steering gear and a controller, for steering.

4. The small aircraft according to claim 2, wherein said propulsion unit comprises a pivotable electric motor having two opposing rotors/propellers for steering, and small aerodynamic roll control surfaces for roll control.

5. The small aircraft according to claim 4, wherein the collapsible or foldable wings are planar wings.

6. The small aircraft according to claim 4, wherein the collapsible or foldable wings are lattice wings.

7. The small aircraft according to claim 3, wherein:
in forward flight, the aircraft is controllable via a primary system of the control surface angle assignment in the manner of a classical Cartesian flying body;
in hovering flight, lateral movement, in x and y directions of the axial system fixed on the aircraft, is controllable via a secondary system; and
changeover of the control systems from forward flight to hovering flight occurs automatically with the transition of the flight state between forward and hover flight.

8. The small aircraft according to claim 4, wherein:
the propeller motor is mounted at the rear of the aircraft, by a cardan joint;
control of the aircraft around two transverse axes is performed by pivoting the motor with the propellers; and
torques which arise despite the opposing propellers are leveled out by the roll control surfaces.

9. The small aircraft according to claim 7, further comprising triaxial miniature gyroscopes for the automatic position or rotational position stabilization.

10. The small aircraft according to claim 1, further comprising a directable TV/IR camera and a data transmission device in a forward end of the aircraft, for transmitting data to an operator, and for transmitting control inputs from the operator to the aircraft.

11. The small aircraft according to claim 1, further comprising replaceable weapon systems.

12. An unmanned aircraft comprising:
a fuselage;
individually controllable wings mounted on the fuselage;
individually controllable control surfaces mounted on the fuselage;
control electronics for controlling orientation of said wings and control surfaces relative to said fuselage;
a propulsion unit mounted to a rear part of the aircraft, said propulsion unit comprising an electric motor and propellers that are rotatable thereby; and
an imaging device mounted to the front part of the aircraft; wherein
said wings, control surfaces and propellers are one of foldable and collapsible, to a position substantially flush with an exterior of said fuselage; and
said propulsion unit and said imaging device are mounted to said fuselage via respective pivotable joints.

13. The unmanned aircraft according to claim 12, wherein said pivotable joints are cardan joints.
